(19) United States
(12) Patent Application Publication
(10) Pub. No.: US 2026/0296358 A1
(43) Pub. Date: Oct. 1, 2026

(54) AIRBAG DEVICE

(71) Applicant: SUBARU CORPORATION, Tokyo (JP)

(72) Inventor: Isamu NAGASAWA, Tokyo (JP)

(21) Appl. No.: 19/559,198

(22) Filed: Mar. 6, 2026

(30) Foreign Application Priority Data
Mar. 31, 2025 (JP) 2025-060091

(51) Int. Cl. B60R 21/2338; B60R 21/231; B60R 21/232; B60R 21/26

(52) U.S. Cl. CPC B60R 21/2338; B60R 21/232; B60R 21/26; B60R 2021/23107; B60R 2021/23388

(57) ABSTRACT

An airbag device includes: a curtain airbag including a first air chamber that comes into contact with a first vehicle body structure when deployed, and a second air chamber that is deployed to a rear side of a vehicle; a first tether that couples the curtain airbag and a second vehicle body structure; a second tether coupled to one or more coupling points provided on the second air chamber; an inflator configured to supply a gas to the curtain airbag when a first collision or a second collision is detected; a cutting device configured to cut off the first tether when the first collision is detected; and a retracting device configured to retract the second tether when the first collision is detected. The first collision is a collision in which an occupant is predicted to head for the first vehicle body structure. The second collision is a side collision.

### CROSS-REFERENCE TO RELATED APPLICATIONS

The present application claims priority from Japanese Patent Application No. 2025-060091 filed on Mar. 31, 2025, the entire contents of which are hereby incorporated by reference.

### BACKGROUND

The disclosure relates to an airbag device.

### SUMMARY

An aspect of the disclosure provides an airbag device configured to be applied an vehicle, the airbag device. The airbag device includes a curtain airbag, a first tether, a second tether, an inflator, a cutting device, and a retracting device. The curtain airbag includes a first air chamber configured to come into contact with a first vehicle body structure disposed obliquely in front of an occupant of the vehicle when deployed, and a second air chamber that is coupled to a rear portion of the first air chamber and configured to be deployed to a rear side of the vehicle from the first air chamber. The curtain airbag is configured to be deployed to a side surface of a vehicle cabin of the vehicle. The first tether couples the curtain airbag and a second vehicle body structure. The second tether is coupled to one or more coupling points provided on an upper portion of the second air chamber of the curtain airbag. The inflator is configured to supply a gas to the curtain airbag when occurrence of a first collision or a second collision of the vehicle is detected. The cutting device is configured to cut off the first tether when the occurrence of the first collision is detected. The retracting device is configured to retract the second tether toward a front side of the vehicle when the occurrence of the first collision is detected. The first collision is a collision in which the occupant is predicted to head for the first vehicle body structure due to the collision of the vehicle. The second collision is a side collision of the vehicle.

### BRIEF DESCRIPTION OF THE DRAWINGS

The accompanying drawings are included to provide a further understanding of the disclosure and are incorporated in and constitute a part of this specification. The drawings illustrate embodiments and, together with the specification, serve to describe the principles of the disclosure.

FIG. 1 is a first schematic view illustrating a schematic configuration of an airbag device according to an embodiment of the disclosure.

FIG. 2 is a second schematic view illustrating a schematic configuration of the airbag device according to the embodiment.

FIG. 3 is a flowchart illustrating an operation flow of the airbag device according to the embodiment.

FIG. 4 is a third schematic view illustrating a schematic configuration of the airbag device according to the embodiment.

FIG. 5 is a schematic view illustrating a schematic configuration of a second air chamber according to a modified example.

FIG. 6 is a schematic view illustrating a schematic configuration of the second air chamber according to a modified example.

FIG. 7 is a schematic view illustrating a schematic configuration of the second air chamber according to a modified example.

### DETAILED DESCRIPTION

A vehicle is provided with an airbag device in order to protect an occupant in a vehicle cabin at the time of a vehicle collision.

For example, Japanese Patent No. 6697805 discloses an airbag device including a curtain airbag deployed on a side surface of a vehicle cabin at the time of a side collision of a vehicle.

It is desirable to develop a technique that can improve occupant protection performance with a curtain airbag deployed on a side surface of a vehicle cabin.

In view of such a problem, it is desirable to provide an airbag device that can improve occupant protection performance.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

### 1. Configuration of Airbag Device

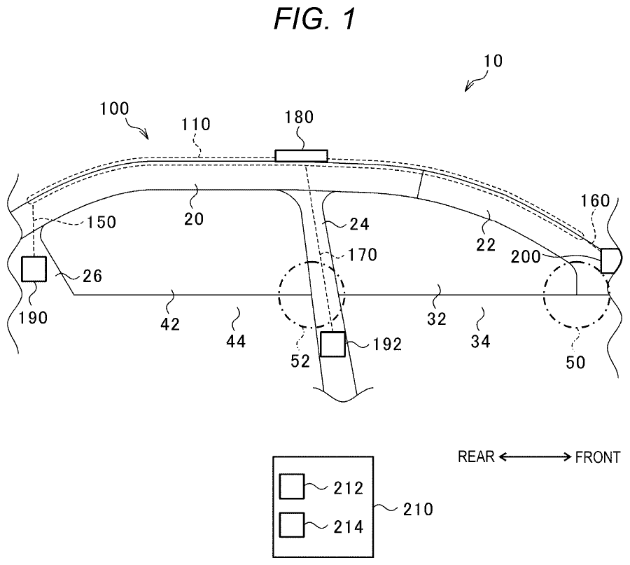

First, an outline of an airbag device 100 according to an embodiment of the disclosure will be described with reference to FIG. 1. FIG. 1 is a first schematic view illustrating a schematic configuration of the airbag device 100 according to an embodiment of the disclosure. FIG. 1 illustrates the airbag device 100 before being deployed.

As illustrated in FIG. 1, the airbag device 100 is disposed in a vehicle cabin of a vehicle 10. The vehicle 10 includes a roof 20, a front pillar 22, a center pillar 24, a C-pillar 26, a front side window 32, a front door trim 34, a rear side window 42, and a rear door trim 44.

The roof 20 is a portion that serves as a roof of the vehicle 10 among vehicle body structures. The front pillar 22 (first vehicle body structure), the center pillar 24 (first vehicle body structure), and the C-pillar 26 (second vehicle body structure) are pillars that support the roof 20 among the vehicle body structures. The front pillar 22 is provided at a front portion of the vehicle 10. The front pillar 22 is disposed obliquely in front of occupants in a driver's seat and a front passenger's seat of the vehicle 10. The front pillar 22 is also called an “A-pillar”. The center pillar 24 is provided at the center of the vehicle 10. The center pillar 24 is disposed obliquely in front of a passenger in a rear seat of the vehicle 10. The center pillar 24 is also called a “B-pillar”. The C-pillar 26 is provided at a rear portion of the vehicle 10.

The front side window 32 is a window disposed in a front portion of the vehicle 10 among windows disposed on a side surface of the vehicle 10. The front side window 32 is provided between the front pillar 22 and the center pillar 24. The front door trim 34 is disposed below the front side window 32 and forms a part of a side wall of the vehicle cabin. The rear side window 42 is a window disposed in a rear portion of the vehicle 10 among the windows disposed on the side surface of the vehicle 10. The rear side window 42 is provided between the center pillar 24 and the C-pillar 26. The rear door trim 44 is disposed below the rear side window 42 and forms a part of the side wall of the vehicle cabin.

The airbag device 100 includes, for example, a curtain airbag 110, a first tether 150, a second tether 160, a third tether 170, an inflator 180, cutting devices 190 and 192, a retracting device 200, and a control device 210.

Before the curtain airbag 110 is deployed, the curtain airbag 110 is accommodated in the vicinity of the roof 20. The first tether 150 couples the curtain airbag 110 and the C-pillar 26 (second vehicle body structure). The second tether 160 and the third tether 170 are coupled to the curtain airbag 110. The cutting device 190 can cut off the first tether 150. The cutting device 190 is provided, for example, in the C-pillar 26 or in the vicinity of the C-pillar 26. The cutting device 192 can cut off the third tether 170. The cutting device 192 is provided, for example, in the center pillar 24 or in the vicinity of the center pillar 24. The retracting device 200 can retract the second tether 160 to a front side of the vehicle 10. The retracting device 200 is disposed, for example, in the front pillar 22, in the vicinity of the front pillar 22, in a dashboard, or in the vicinity of the dashboard.

The control device 210 includes one or more processors 212 and one or more memories 214 coupled to the processors 212. The processor 212 includes, for example, a central processing unit (CPU). The memory 214 includes, for example, a read only memory (ROM) and a random access memory (RAM). The ROM is a storage element that stores a program, a calculation parameter, and the like to be used by the CPU. The RAM is a storage element that temporarily stores data such as a variable and a parameter to be used for processing executed by the CPU. The processor 212 of the control device 210 executes a program included in the memory 214 to execute various kinds of processing of the control device 210.

The control device 210 controls the inflator 180, the cutting devices 190 and 192, and the retracting device 200.

The control device 210 detects occurrence of a collision of the vehicle 10. For example, the control device 210 detects occurrence of a collision of the vehicle 10 based on a detection value of an acceleration sensor (not illustrated). In the present embodiment, the control device 210 detects occurrence of a first collision and a second collision among collisions of the vehicle 10.

The first collision is a collision in which an occupant is predicted to head for the front pillar 22 or the center pillar 24 due to a collision of the vehicle 10. In one example, the first collision is a collision in which a head of an occupant is predicted to head for the front pillar 22 or the center pillar 24 due to a collision of the vehicle 10. The first collision is also called an offset collision. The second collision is a side collision of the vehicle 10.

When the first collision occurs, a head of an occupant moves toward the front pillar 22 or the center pillar 24 to indicate a yaw behavior. Therefore, when the first collision occurs, the head of the occupant may collide with a region 50 or a region 52 illustrated in FIG. 1. The region 50 is a region extending from the front pillar 22 to a front portion of the front door trim 34. The region 52 is a region extending from the center pillar 24 to a front portion of the rear door trim 44. Therefore, when the curtain airbag 110 is deployed, the volume of an air chamber that comes into contact with the regions 50 and 52 may be increased. However, in this case, there are problems such as difficulty in stably deploying the air chamber, difficulty in deploying the air chamber at high speed, and risk of damaging the front door trim 34 or the rear door trim 44 during deployment.

Therefore, by devising a shape of the curtain airbag 110, the airbag device 100 according to the present embodiment can improve occupant protection performance even when the first collision or the second collision occurs. Hereinafter, details of the curtain airbag 110, the first tether 150, the second tether 160, the third tether 170, the inflator 180, the cutting devices 190 and 192, the retracting device 200, and the control device 210 will be described.

### 1.1. Outline of Curtain Airbag

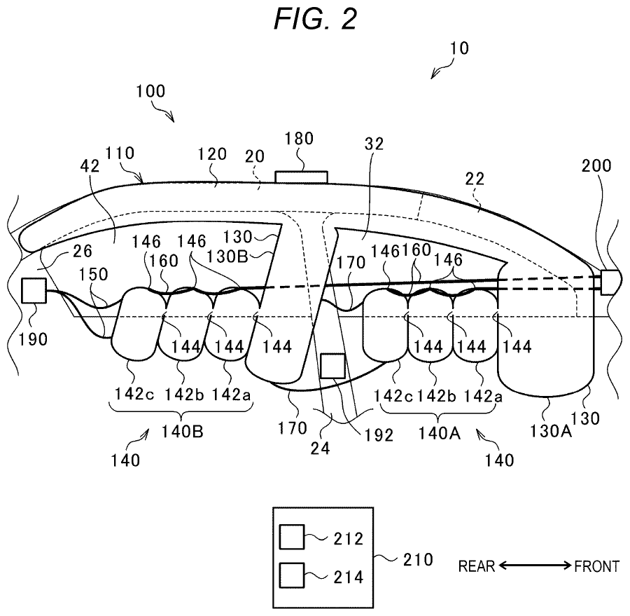

Next, an outline of the curtain airbag 110 after being deployed according to the present embodiment will be described with reference to FIG. 2. FIG. 2 is a second schematic view illustrating a schematic configuration of the airbag device 100 according to the present embodiment. FIG. 2 illustrates the airbag device 100 in a first state after being deployed, which will be described later.

As illustrated in FIG. 2, the curtain airbag 110 is deployed to a side surface of the vehicle cabin of the vehicle 10. The curtain airbag 110 has a bag shape. The curtain airbag 110 includes, for example, an upper air chamber 120, a first air chamber 130, and a second air chamber 140.

The upper air chamber 120 extends along the roof 20 and the front pillar 22 in a front-rear direction of the vehicle 10 when deployed. The upper air chamber 120 comes into contact with a region extending across a lower portion of the roof 20 of the vehicle 10, an upper portion of the front pillar 22, an upper portion of the front side window 32, an upper portion of the center pillar 24, and an upper portion of the rear side window 42 so as to cover these portions when deployed.

The first air chamber 130 is provided below the upper air chamber 120 when deployed. For example, the first air chamber 130 communicates with the upper air chamber 120. In the present embodiment, the first air chamber 130 includes a front first air chamber 130A and a center first air chamber 130B.

The front first air chamber 130A extends downward from the upper air chamber 120 when deployed. The front first air chamber 130A comes into contact with the front pillar 22 to cover the front pillar 22 when deployed. In the present embodiment, the front first air chamber 130A covers a region extending across a front portion of the front pillar 22, a front portion of the front side window 32, and a front portion of the front door trim 34.

The center first air chamber 130B extends downward from the upper air chamber 120 when deployed. The center first air chamber 130B comes into contact with the center pillar 24 to cover the center pillar 24 when deployed. In the present embodiment, the center first air chamber 130B covers a region extending across a front portion of the center pillar 24, a front portion of the rear side window 42, and a front portion of the rear door trim 44.

The second air chamber 140 is coupled to a rear portion of the first air chamber 130 and is deployed to a rear side of the vehicle 10 from the first air chamber 130. In the present embodiment, the second air chamber 140 includes a front second air chamber 140A and a center second air chamber 140B.

The front second air chamber 140A is coupled to a rear portion of the front first air chamber 130A and is deployed to a rear side of the vehicle 10 from the front first air chamber 130A. In one example, the front second air chamber 140A is deployed from the front first air chamber 130A toward the center pillar 24. The front second air chamber 140A covers a region extending across a lower portion of the front side window 32 and an upper portion of the front door trim 34.

In the present embodiment, the front second air chamber 140A includes three small air chambers 142a, 142b, and 142c. A communication port 144 is formed in an upper portion of each of the three small air chambers 142a, 142b, and 142c. The three small air chambers 142a, 142b, and 142c of the front second air chamber 140A communicate with the front first air chamber 130A through the communication ports 144.

The center second air chamber 140B is coupled to a rear portion of the center first air chamber 130B and is deployed to a rear side of the vehicle 10 from the center first air chamber 130B. In one example, the center second air chamber 140B is deployed from the center first air chamber 130B toward the C-pillar 26. The center second air chamber 140B covers a region extending across a lower portion of the rear side window 42 and an upper portion of the rear door trim 44.

In the present embodiment, similar to the front second air chamber 140A, the center second air chamber 140B includes three small air chambers 142a, 142b, and 142c. A communication port 144 is formed in an upper portion of each of the three small air chambers 142a, 142b, and 142c. The three small air chambers 142a, 142b, and 142c of the center second air chamber 140B communicate with the center first air chamber 130B through the communication ports 144.

### 1.2. Outline of First Tether, Second Tether, and Third Tether

As illustrated in FIG. 2, the first tether 150, the second tether 160, and the third tether 170 have a string shape.

The first tether 150 couples the curtain airbag 110 and the C-pillar 26. In the present embodiment, the first tether 150 couples the small air chamber 142c at the rear-most portion of the center second air chamber 140B to the C-pillar 26. In the present embodiment, two first tethers 150 are provided.

The second tether 160 is coupled to one or more coupling points 146 provided on an upper portion of the second air chamber 140 of the curtain airbag 110. In the present embodiment, the second tether 160 couples the retracting device 200 to the one or more coupling points 146 provided on the upper portion of the second air chamber 140 of the curtain airbag 110.

In the present embodiment, two second tethers 160 are provided. One of the second tethers 160 couples the coupling point 146 provided at an upper portion of the front second air chamber 140A to the retracting device 200. The other second tether 160 couples the coupling point 146 provided at the upper portion of the center second air chamber 140B to the retracting device 200. In one example, one of the second tethers 160 couples the retracting device 200 to the three coupling points 146 provided at upper portions of the three small air chambers 142a, 142b, and 142c of the front second air chamber 140A. The other second tether 160 couples the retracting device 200 to the three coupling points 146 provided at upper portions of the three small air chambers 142a, 142b, and 142c of the center second air chamber 140B. One of the second tethers 160 is coupled to the front second air chamber 140A from the retracting device 200 through the front side window 32 at the front first air chamber 130A. Similarly, the other second tether 160 is coupled to the center second air chamber 140B from the retracting device 200 through the front side window 32 at the front first air chamber 130A and the rear side window 42 at the center first air chamber 130B.

The third tether 170 couples the front second air chamber 140A and the center first air chamber 130B. In the present embodiment, the third tether 170 couples the small air chamber 142c at the rear-most portion of the front second air chamber 140A to the center first air chamber 130B. In the present embodiment, two third tethers 170 are provided.

### 1.3. Outline of Inflator, Cutting Device, and Retracting Device

The inflator 180 supplies a gas to the curtain airbag 110 when occurrence of the first collision or the second collision of the vehicle 10 is detected. Accordingly, the curtain airbag 110 is inflated and deployed.

The cutting device 190 cuts off the first tether 150 when occurrence of the first collision of the vehicle 10 is detected. The cutting device 190 does not cut off the first tether 150 when occurrence of the second collision is detected. The cutting device 192 cuts off the third tether 170 when occurrence of the first collision is detected. The cutting device 192 does not cut off the third tether 170 when occurrence of the second collision is detected. Each of the cutting devices 190 and 192 includes, for example, an inflator and a cutting blade.

When occurrence of the first collision of the vehicle 10 is detected, the retracting device 200 retracts the second tether 160 toward a front side of the vehicle 10. The retracting device 200 does not retract the second tether 160 when occurrence of the second collision is detected. The retracting device 200 includes, for example, an inflator.

### 2. Operation of Airbag Device

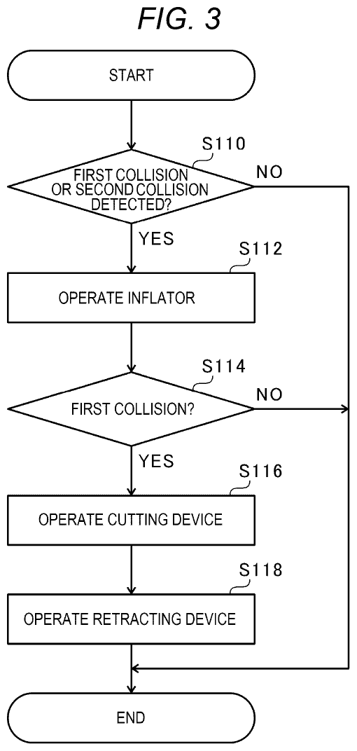

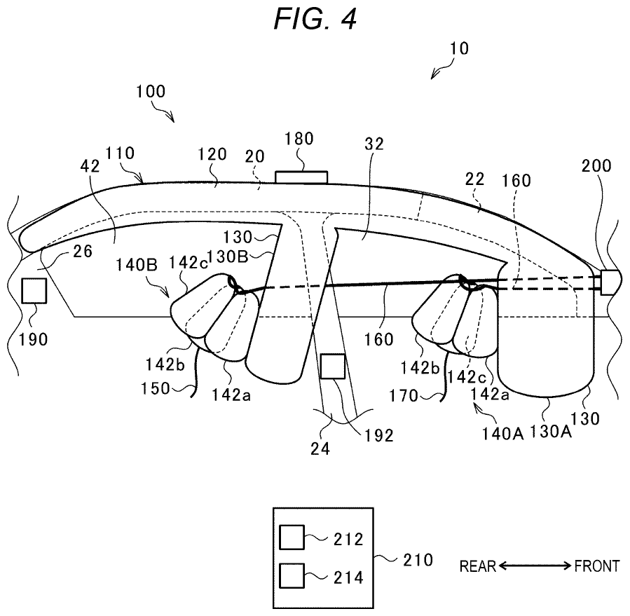

Next, an operation of the airbag device 100 according to the present embodiment will be described with reference to FIGS. 2 to 4. FIG. 3 is a flowchart illustrating an operation of the airbag device 100 according to the present embodiment. FIG. 4 is a third schematic view illustrating a schematic configuration of the airbag device 100 according to the present embodiment. FIG. 4 illustrates the airbag device 100 in a second state after being deployed, which will be described later.

A processing flow illustrated in FIG. 3 is repeated, for example, at a preset time interval of, for example, 6 msec.

In step S110, the control device 210 determines whether occurrence of the first collision or the second collision of the vehicle 10 is detected. As a result, the control device 210 proceeds the processing to step S112 when it is determined that the occurrence of the first collision or the second collision of the vehicle 10 is detected (YES in step S110). On the other hand, the control device 210 ends the processing flow illustrated in FIG. 3 when it is determined that the occurrence of the first collision and the second collision of the vehicle 10 is not detected (NO in step S110).

In step S112, the control device 210 operates the inflator 180. Accordingly, a gas is supplied from the inflator 180 to the curtain airbag 110, and the curtain airbag 110 is inflated. In this manner, the curtain airbag 110 is deployed in the first state illustrated in FIG. 2.

Next to step S112, in step S114, the control device 210 determines whether the collision detected in step S110 is the first collision of the vehicle 10. As a result, the control device 210 proceeds the processing to step S116 when it is determined that the collision is the first collision of the vehicle 10 (YES in step S114). On the other hand, the control device 210 ends the processing flow illustrated in FIG. 3 when it is determined that the collision is not the first collision of the vehicle 10, that is, when it is determined that the collision is the second collision (NO in step S114).

In step S116, the control device 210 operates the cutting devices 190 and 192. Accordingly, the first tether 150 and the third tether 170 are cut off. In this case, the center second air chamber 140B and the C-pillar 26 are uncoupled, and the front second air chamber 140A and the center first air chamber 130B are uncoupled.

In step S118, the control device 210 operates the retracting device 200. Accordingly, the second tether 160 is retracted to a front side of the vehicle 10.

In this case, as illustrated in FIG. 4, one of the second tethers 160 is retracted to the front side of the vehicle 10, so that upper portions (coupling points 146) of the three small air chambers 142a, 142b, and 142c of the front second air chamber 140A are retracted toward the front first air chamber 130A. On the other hand, lower portions of the three small air chambers 142a, 142b, and 142c of the front second air chamber 140A are not retracted by the one second tether 160. Accordingly, the upper portions of the three small air chambers 142a, 142b, and 142c of the front second air chamber 140A converge toward the front first air chamber 130A.

In one example, by retracting the one second tether 160, first, the upper portion of the small air chamber 142a disposed front-most among the three small air chambers 142a, 142b, and 142c is retracted toward the front first air chamber 130A. In this case, the gas in the upper portion of the small air chamber 142a moves to the front first air chamber 130A through the communication port 144, and the upper portion of the small air chamber 142a is contracted. When the one second tether 160 is further retracted, the upper portion of the small air chamber 142b disposed in the center among the three small air chambers 142a, 142b, and 142c is retracted toward the front first air chamber 130A. In this case, the gas in the upper portion of the small air chamber 142b moves to the front first air chamber 130A through the communication port 144, and the upper portion of the small air chamber 142b is contracted. When the one second tethers 160 is further retracted, the upper portion of the small air chamber 142c disposed rear-most among the three small air chambers 142a, 142b, and 142c is retracted toward the front first air chamber 130A. In this case, the gas in the upper portion of the small air chamber 142c moves to the front first air chamber 130A through the communication port 144, and the upper portion of the small air chamber 142c is contracted.

Pressure in the front first air chamber 130A rises due to the gas in the three small air chambers 142a, 142b, and 142c moving to the front first air chamber 130A. Accordingly, lower portions of the three small air chambers 142a, 142b, and 142c are pushed back by the front first air chamber 130A. The upper portions of the three small air chambers 142a, 142b, and 142c of the front second air chamber 140A are contracted, so that the gas in the upper portions of the three small air chambers 142a, 142b, and 142c moves to the lower portions of the three small air chambers 142a, 142b, and 142c. In this case, pressure in the lower portions of the three small air chambers 142a, 142b, and 142c of the front second air chamber 140A rises, and the lower portions of the three small air chambers 142a, 142b, and 142c repel each other. Accordingly, the front second air chamber 140A is deformed into an approximately triangular pyramid shape. In one example, the front second air chamber 140A is deformed into an approximately triangular pyramid shape having a top portion disposed upward and a bottom portion disposed downward.

Similarly, when the other second tether 160 is retracted to the front side of the vehicle 10, upper portions (coupling points 146) of the three small air chambers 142a, 142b, and 142c of the center second air chamber 140B are retracted toward the center first air chamber 130B. On the other hand, lower portions of the three small air chambers 142a, 142b, and 142c of the center second air chamber 140B are not retracted by the other second tether 160. Accordingly, the upper portions of the three small air chambers 142a, 142b, and 142c of the center second air chamber 140B converge toward the center first air chamber 130B. Pressure in the center second air chamber 140B rises due to the gas in the three small air chambers 142a, 142b, and 142c moving to the center second air chamber 140B. Accordingly, the lower portions of the three small air chambers 142a, 142b, and 142c are pushed back by the center second air chamber 140B. The gas in the upper portions of the three small air chambers 142a, 142b, and 142c of the center second air chamber 140B moves to the lower portions of the three small air chambers 142a, 142b, and 142c. In this case, pressure in the lower portions of the three small air chambers 142a, 142b, and 142c of the center second air chamber 140B rises, and the lower portions of the three small air chambers 142a, 142b, and 142c repel each other. Accordingly, the center second air chamber 140B is deformed into an approximately triangular pyramid shape. In one example, the center second air chamber 140B is deformed into an approximately triangular pyramid shape having a top portion disposed upward and a bottom portion disposed downward.

In this manner, when the occurrence of the first collision is detected, the airbag device 100 according to the embodiment further deforms the curtain airbag 110 in the first state as illustrated in FIG. 2 into the curtain airbag 110 in the second state including the front second air chamber 140A having a cone shape and the center second air chamber 140B having a cone shape.

### 3. Effects of Airbag Device

The airbag device 100 according to the embodiment of the disclosure has been described above.

The airbag device 100 according to the embodiment includes: the curtain airbag 110 including the first air chamber 130 that comes into contact with the first vehicle body structure (the front pillar 22 and the center pillar 24) disposed obliquely in front of an occupant of the vehicle 10 when deployed, and the second air chamber 140 that is coupled to a rear portion of the first air chamber 130 and is deployed to a rear side of the vehicle 10 from the first air chamber 130, the curtain airbag 110 being deployed to a side surface of the vehicle cabin of the vehicle 10; the first tether 150 that couples the curtain airbag 110 and the second vehicle body structure (the C-pillar 26); the second tether 160 that is coupled to two or more coupling points 146 provided on the upper portion of the second air chamber 140 of the curtain airbag 110; the inflator 180 that supplies a gas to the curtain airbag 110 when the occurrence of the first collision or the second collision of the vehicle 10 is detected; the cutting device 190 that cuts off the first tether 150 when the occurrence of the first collision is detected; and the retracting device 200 that retracts the second tether 160 toward a front side of the vehicle 10 when the occurrence of the first collision is detected. The first collision is a collision in which an occupant is predicted to head for the first vehicle body structure due to a collision of the vehicle 10, and the second collision is a side collision of the vehicle 10.

Accordingly, the airbag device 100 according to the present embodiment can appropriately protect an occupant when the occurrence of the second collision, which is a side collision of the vehicle 10, is detected. The airbag device 100 according to the embodiment can move the second air chamber 140 toward the first vehicle body structure when the occurrence of the first collision, in which an occupant is predicted to head for the first vehicle body structure due to the collision of the vehicle 10, is detected. Therefore, when the occurrence of the first collision is detected, the airbag device 100 according to the embodiment can increase a thickness of the second air chamber 140 that comes into contact with the region 50 extending from the front pillar 22 to the front portion of the front door trim 34 or the region 52 extending from the center pillar 24 to the front portion of the rear door trim 44. Accordingly, the airbag device 100 can obtain a reactive force from the region 50 or the region 52 via the second air chamber 140, and can appropriately protect the occupant even when the first collision occurs. In this manner, the airbag device 100 according to the present embodiment can appropriately protect the occupant even when the occurrence of the first collision is detected or when the occurrence of the second collision is detected, so that occupant protection performance can be improved.

The cutting device 190 may not cut off the first tether 150 when the occurrence of the second collision is detected, and the retracting device 200 may not retract the second tether 160 when the occurrence of the second collision is detected.

In this manner, the cutting device 190 and the retracting device 200 according to the present embodiment are operated when the occurrence of the second collision of the vehicle 10 is not detected and the occurrence of the first collision is detected. The cutting device 190 and the retracting device 200 are not operated when the occurrence of the first collision of the vehicle 10 is not detected and the occurrence of the second collision is detected. Therefore, the airbag device 100 according to the present embodiment can increase the thickness of the second air chamber 140 when the occurrence of the first collision is detected. That is, the airbag device 100 according to the present embodiment does not increase the thickness of the second air chamber 140 when the occurrence of the second collision is detected. Accordingly, the airbag device 100 according to the present embodiment can stably deploy the curtain airbag 110 at high speed when the curtain airbag 110 is deployed by the inflator 180. The airbag device 100 according to the present embodiment can prevent damage to the front door trim 34 or the rear door trim 44 at the time of deployment.

The second air chamber 140 may be deformed into a cone shape when the second tether 160 is retracted by the retracting device 200.

Accordingly, when the occurrence of the first collision is detected, the airbag device 100 according to the present embodiment can further increase the thickness of the second air chamber 140 that comes into contact with the region 50 extending from the front pillar 22 to the front portion of the front door trim 34 or the region 52 extending from the center pillar 24 to the front portion of the rear door trim 44. Accordingly, the airbag device 100 can efficiently obtain a reactive force from the region 50 or the region 52, and can more appropriately protect the occupant even when the first collision occurs.

The second air chamber 140 of the curtain airbag 110 may communicate with the first air chamber 130 of the curtain airbag 110 through the communication port 144 formed in an upper portion of the second air chamber 140.

Accordingly, the airbag device 100 according to the present embodiment can deploy the first air chamber 130 and the second air chamber 140 in a pre-designed deployment order. Therefore, the airbag device 100 according to the present embodiment can more appropriately protect the occupant even when the occurrence of the first collision is detected or when the occurrence of the second collision is detected. In the airbag device 100 according to the present embodiment, the retracting device 200 can easily converge the upper portion of the second air chamber 140 toward the first air chamber 130. Accordingly, the airbag device 100 according to the present embodiment can appropriately deform the second air chamber 140 into a cone shape.

The second air chamber 140 of the curtain airbag 110 may include the small air chambers 142a, 142b, and 142c, and the communication port 144 may be formed in an upper portion of each of the small air chambers 142a, 142b, and 142c.

Accordingly, the airbag device 100 according to the present embodiment can deploy the first air chamber 130 and the small air chambers 142a, 142b, and 142c of the second air chamber 140 in a pre-designed deployment order. Therefore, the airbag device 100 according to the present embodiment can more appropriately protect the occupant even when the occurrence of the first collision is detected or when the occurrence of the second collision is detected. In the airbag device 100 according to the present embodiment, the retracting device 200 can easily converge the upper portions of the small air chambers 142a, 142b, and 142c of the second air chamber 140 toward the first air chamber 130. Accordingly, the airbag device 100 according to the present embodiment can appropriately deform the small air chambers 142a, 142b, and 142c of the second air chamber 140 into a cone shape.

The first vehicle body structure may include the front pillar 22 and the center pillar 24. The first air chamber 130 of the curtain airbag 110 may include the front first air chamber 130A that comes into contact with the front pillar 22 when deployed and the center first air chamber 130B that comes into contact with the center pillar 24 when deployed. The second air chamber 140 of the curtain airbag 110 may include the front second air chamber 140A that is coupled to a rear portion of the front first air chamber 130A and is deployed to a rear side of the vehicle 10 from the front first air chamber 130A, and the center second air chamber 140B that is coupled to a rear portion of the center first air chamber 130B and is deployed to the rear side of the vehicle 10 from the center first air chamber 130B.

Accordingly, even when the occurrence of the first collision is detected and when the occurrence of the second collision is detected, the airbag device 100 according to the present embodiment can more appropriately protect occupants in a driver's seat, a front passenger's seat, and a rear seat.

### 4. Modified Example

An example has been described above in which the second tether 160 is coupled to the three coupling points provided on the upper portion of the second air chamber 140. Alternatively, the second tether 160 may be coupled to one or more coupling points 146 provided on the upper portion of the second air chamber 140. In such a case, the second air chamber 140 can also be deformed into a cone shape by retracting the second tether 160 with the retracting device 200.

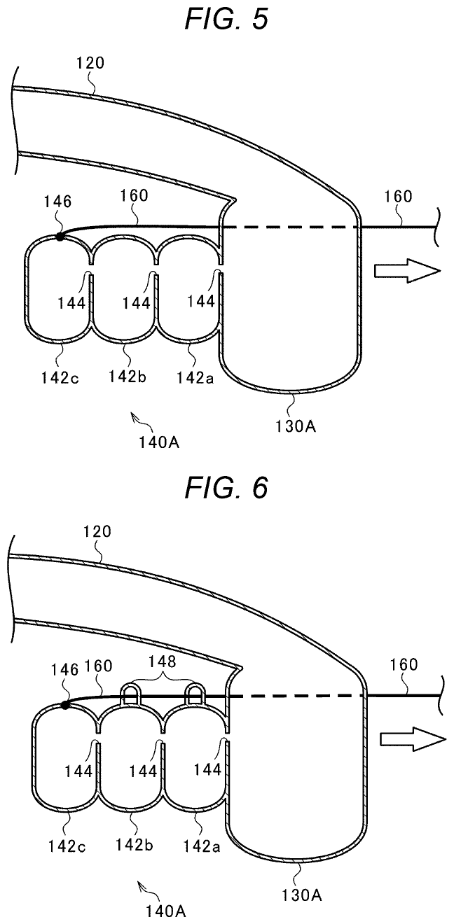

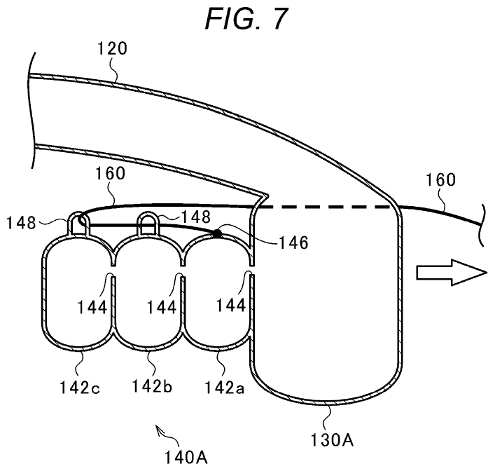

FIG. 5 is a schematic view illustrating a schematic configuration of the second air chamber 140 according to a first modified example. FIG. 6 is a schematic view illustrating a schematic configuration of the second air chamber 140 according to a second modified example. FIG. 7 is a schematic view illustrating a schematic configuration of the second air chamber 140 according to a third modified example. Although the front second air chamber 140A is illustrated in FIGS. 5 to 7, the same applies to the center second air chamber 140B.

As illustrated in FIG. 5, in the first modified example, the second tether 160 is coupled to the coupling point 146 provided on the upper portion of the small air chamber 142c disposed rear-most among the three small air chambers 142a, 142b, and 142c of the front second air chamber 140A.

In the first modified example, the front second air chamber 140A is also deformed into an approximately triangular pyramid shape having a top portion disposed upward and a bottom portion disposed downward. Accordingly, when the occurrence of the first collision is detected, the thickness of the front second air chamber 140A that comes into contact with the region 50 extending from the front pillar 22 to the front portion of the front door trim 34 can be further increased. Therefore, in the first modified example, a reactive force can be efficiently obtained from the region 50, and an occupant can be more appropriately protected even when the first collision occurs.

As illustrated in FIG. 6, in the second modified example, an annular insertion ring 148 is provided on an upper portion of each of the small air chambers 142a and 142b of the front second air chamber 140A. In the second modified example, the second tether 160 is coupled to the coupling point 146 provided on the upper portion of the small air chamber 142c disposed rear-most among the three small air chambers 142a, 142b, and 142c of the front second air chamber 140A in a similar manner to the first modified example. In the second modified example, the second tether 160 coupled to the coupling point 146 provided on the upper portion of the small air chamber 142c is inserted through the insertion ring 148 provided on the small air chamber 142b, then is inserted through the insertion ring 148 provided on the small air chamber 142a, and is coupled to the retracting device 200.

In the second modified example, the front second air chamber 140A is also deformed into an approximately triangular pyramid shape having a top portion disposed upward and a bottom portion disposed downward. Accordingly, when the occurrence of the first collision is detected, the thickness of the front second air chamber 140A that comes into contact with the region 50 extending from the front pillar 22 to the front portion of the front door trim 34 can be further increased. Therefore, in the second modified example, a reactive force can be efficiently obtained from the region 50, and an occupant can be more appropriately protected even when the first collision occurs.

In the second modified example, a top portion of the front second air chamber 140A can be aggregated into one location. Accordingly, a lower portion of the front second air chamber 140A can protrude further into the vehicle cabin in the second modified example. Therefore, the thickness of the front second air chamber 140A that comes into contact with the region 50 can be further increased in the second modified example.

As illustrated in FIG. 7, in the third modified example, the annular insertion ring 148 is provided on an upper portion of each of the small air chambers 142b and 142c of the front second air chamber 140A, which is different from the second modified example. In the third modified example, the second tether 160 is coupled to the coupling point 146 provided on the upper portion of the small air chamber 142a disposed front-most among the three small air chambers 142a, 142b, and 142c of the front second air chamber 140A. In the third modified example, the second tether 160 coupled to the coupling point 146 provided on the upper portion of the small air chamber 142a is inserted through the insertion ring 148 provided on the small air chamber 142b, then is inserted through the insertion ring 148 provided on the small air chamber 142c, and is coupled to the retracting device 200.

In the third modified example, the front second air chamber 140A is also deformed into an approximately triangular pyramid shape having a top portion disposed upward and a bottom portion disposed downward. Accordingly, when the occurrence of the first collision is detected, the thickness of the front second air chamber 140A that comes into contact with the region 50 extending from the front pillar 22 to the front portion of the front door trim 34 can be further increased. Therefore, in the third modified example, a reactive force can be efficiently obtained from the region 50, and an occupant can be more appropriately protected even when the first collision occurs.

The embodiments of the disclosure have been described above with reference to the accompanying drawings. It is needless to say that the disclosure is not limited to such embodiments. It will be apparent to those skilled in the art that various changes and modified examples may be made within the scope of the claims. It should be understood that such changes and modified examples also fall within the technical scope of the disclosure.

For example, the configuration of the airbag device 100 has been described above with reference to FIG. 1. Alternatively, some elements may be omitted or an element may be added to the airbag device 100.

An example has been described above in which the first air chamber 130 includes the front first air chamber 130A and the center first air chamber 130B, and the second air chamber 140 includes the front second air chamber 140A and the center second air chamber 140B. Alternatively, the curtain airbag 110 may include the front first air chamber 130A and the front second air chamber 140A, or the center first air chamber 130B and the center second air chamber 140B. When the curtain airbag 110 does not include the center first air chamber 130B and the center second air chamber 140B but includes the front first air chamber 130A and the front second air chamber 140A, the first tether 150 couples the front second air chamber 140A and the center pillar 24 (second vehicle body structure). The curtain airbag 110 may include the first air chamber 130 that is disposed obliquely in front of an occupant of the vehicle 10 when deployed and that comes into contact with a first vehicle body structure other than the front pillar 22 and the center pillar 24, and the second air chamber 140 that is coupled to a rear portion of the first air chamber 130 and is deployed to a rear side of the vehicle 10 from the first air chamber 130.

An example has been described above in which the second air chamber 140 of the curtain airbag 110 includes the three small air chambers 142a, 142b, and 142c. Alternatively, the second air chamber 140 may include two small air chambers or four or more small air chambers. The second air chamber 140 may include one air chamber. In such a case, the second air chamber 140 can also be deformed into a cone shape by retracting the second tether 160 with the retracting device 200.

An example has been described above in which the communication port 144 is formed in the upper portion of each of the small air chambers 142a, 142b, and 142c. Alternatively, the communication port 144 may be formed in any one or more of the small air chambers 142a, 142b, and 142c. The communication port 144 may be not formed in the small air chambers 142a, 142b, and 142c. In this case, a gas is directly supplied from the inflator 180 to a small air chamber that is not formed with the communication port 144.

An example has been described above in which the second air chamber 140 communicates with the first air chamber 130 through the communication port 144 formed in the upper portion of the second air chamber 140. Alternatively, the communication port 144 may be formed at a position other than the upper portion of the second air chamber 140. The communication port 144 may be not formed in the second air chamber 140. In this case, a gas is directly supplied from the inflator 180 to the second air chamber 140.

Similarly, an example has been described in which the first air chamber 130 communicates with the upper air chamber 120 through a communication port formed in the upper portion of the first air chamber 130. Alternatively, the communication port may be formed at a position other than the upper portion of the first air chamber 130. The communication port may be not formed in the first air chamber 130. In this case, a gas is directly supplied from the inflator 180 to the first air chamber 130.

An example has been described in which the second air chamber 140 is deformed into a cone shape by retracting the second tether 160 with the retracting device 200. Alternatively, the second air chamber 140 may be not deformed into a cone shape when the second tether 160 is retracted by the retracting device 200. For example, the second air chamber 140 may be deformed into a spherical shape when the second tether 160 is retracted by the retracting device 200. In any case, the second air chamber 140 may move toward the first air chamber 130 by retracting the second tether 160 with the retracting device 200, and a thickness of a portion that comes into contact with a region extending from the first vehicle body structure to a front portion of a door trim may be increased.

An example has been described above in which the cutting device 190 does not cut off the first tether 150 when the occurrence of the second collision is detected, and the retracting device 200 does not retract the second tether 160 when the occurrence of the second collision is detected. Alternatively, the cutting device 190 may cut off the first tether 150 when the occurrence of the second collision is detected, and the retracting device 200 may retract the second tether 160 when the occurrence of the second collision is detected.

According to the embodiment of the disclosure, it is possible to improve occupant protection performance.

1. An airbag device configured to be applied a vehicle, the airbag device comprising:
a curtain airbag comprising a first air chamber configured to come into contact with a first vehicle body structure disposed obliquely in front of an occupant of the vehicle when deployed, and a second air chamber that is coupled to a rear portion of the first air chamber and configured to be deployed to a rear side of the vehicle from the first air chamber, the curtain airbag being configured to be deployed to a side surface of a vehicle cabin of the vehicle;
a first tether that couples the curtain airbag and a second vehicle body structure;
a second tether that is coupled to one or more coupling points provided on an upper portion of the second air chamber of the curtain airbag;
an inflator configured to supply a gas to the curtain airbag when occurrence of a first collision or a second collision of the vehicle is detected;
a cutting device configured to cut off the first tether when the occurrence of the first collision is detected; and
a retracting device configured to retract the second tether toward a front side of the vehicle when the occurrence of the first collision is detected, wherein
the first collision is a collision in which the occupant is predicted to head for the first vehicle body structure due to the collision of the vehicle, and
the second collision is a side collision of the vehicle.

2. The airbag device according to claim 1, wherein
the cutting device is configured not to cut off the first tether when the occurrence of the second collision is detected, and
the retracting device is configured not to retract the second tether when the occurrence of the second collision is detected.

3. The airbag device according to claim 1, wherein
the second air chamber is configured to be deformed into a cone shape when the second tether is retracted by the retracting device.

4. The airbag device according to claim 2, wherein
the second air chamber is configured to be deformed into a cone shape when the second tether is retracted by the retracting device.

5. The airbag device according to claim 3, wherein
the second air chamber of the curtain airbag communicates with the first air chamber of the curtain airbag through a communication port provided in the upper portion of the second air chamber.

6. The airbag device according to claim 4, wherein
the second air chamber of the curtain airbag communicates with the first air chamber of the curtain airbag through a communication port provided in the upper portion of the second air chamber.

7. The airbag device according to claim 5, wherein
the second air chamber of the curtain airbag includes a plurality of small air chambers, and
the communication port is provided in an upper portion of each of the small air chambers.

8. The airbag device according to claim 6, wherein
the second air chamber of the curtain airbag includes a plurality of small air chambers, and
the communication port is provided in an upper portion of each of the small air chambers.

9. The airbag device according to claim 1, wherein
the first vehicle body structure comprises a front pillar and a center pillar,
the first air chamber of the curtain airbag comprises
a front first air chamber configured to come into contact with the front pillar when deployed, and
a center first air chamber configured to come into contact with the center pillar when deployed, and
the second air chamber of the curtain airbag comprises
a front second air chamber that is coupled to a rear portion of the front first air chamber and configured to be deployed to the rear side of the vehicle from the front first air chamber, and
a center second air chamber that is coupled to a rear portion of the center first air chamber and configured to be deployed to the rear side of the vehicle from the center first air chamber.

10. The airbag device according to claim 2, wherein
the first vehicle body structure comprises a front pillar and a center pillar,
the first air chamber of the curtain airbag comprises
a front first air chamber configured to come into contact with the front pillar when deployed, and
a center first air chamber configured to come into contact with the center pillar when deployed, and
the second air chamber of the curtain airbag comprises
a front second air chamber that is coupled to a rear portion of the front first air chamber and configured to be deployed to the rear side of the vehicle from the front first air chamber, and
a center second air chamber that is coupled to a rear portion of the center first air chamber and configured to be deployed to the rear side of the vehicle from the center first air chamber.
